(19) United States
(12) Patent Application Publication
(10) Pub. No.: US 2007/0010404 A1
(43) Pub. Date: Jan. 11, 2007

(54) Corrosion inhibitor or intensifier for use in acidizing treatment fluids

(75) Inventors: Thomas D. Welton, Duncan, OK (US); Juanita M. Cassidy, Duncan, OK (US)

Correspondence Address: Robert A. Kent, 2600 S. 2nd Street, Duncan, OK, 73536-0440, US

(73) Assignee: Halliburton Energy Services, Inc.

(21) Appl. No.: 11/177,512

(22) Filed: Jul. 8, 2005

(51) Int. Cl. C09K 8/60

(52) U.S. Cl. 507/267

(57) ABSTRACT

The invention also provides a composition for treating a subterranean formation penetrated by a wellbore. The composition is especially useful in acidizing treatments, which when combined with a corrosive aqueous fluid, inhibits the corrosion of metal surfaces, most especially, “duplex” chrome steel surfaces. An advantageous embodiment of the invention comprises at least 0.01% by weight of 3-hydroxypropionic acid and at least 1% by weight of an acid or acid precursor that different from 3-hydroxypropionic acid. The invention also provides a method for treating a subterranean formation penetrated by a wellbore. The method comprises the steps of forming the composition and introducing the composition into the subterranean formation through the wellbore.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO MICROFICHE APPENDIX

Not applicable

### FIELD OF THE INVENTION

The invention generally relates to compositions and methods for treating a subterranean formation. More specifically, the invention relates to compositions and methods using a corrosion inhibitor or inhibitor intensifier in acidizing treatment fluids.

### BACKGROUND OF THE INVENTION

Acid treatments are used to stimulate and increase the production of hydrocarbons in a subterranean formation. This is commonly referred to as acidizing. One such aqueous acid treatment, referred to as “matrix-acidizing”, involves the introduction of an acid into a subterranean formation under pressure so that the acid flows through the pore spaces of the formation. The acid of the aqueous acid treatment reacts with acid soluble materials contained in the formation to increase the size of the pore spaces and increase the permeability of the formation. Another similar treatment known as “fracture-acidizing” involves the formation of one or more fractures in the formation and the introduction of an acid into the fractures to etch the fracture faces and form channels. Acid treatments are also utilized to do other functions such as wellbore and perforation cleanouts, scale removal, filter cake removal, and fluid loss “pill” removal.

A problem that often accompanies the acidizing treatments described above is the corrosion of metal in pumps, well tubular and casing equipment, and equipment that is used to introduce the acid treatments into the subterranean formation to be treated. It is expensive to repair or replace the corroded equipment. The corrosion of equipment is increased by elevated temperatures encountered in deep formations. Also, the corrosion results in at least the partial neutralization of the acid in the acidizing treatment before it reacts with the acid-soluble materials in the formation.

To resist corrosive effects on metals that are employed in wells, more resistive alloys that contain high concentrations of chromium and nickel have been developed. Increasingly, “duplex” chrome steels are being employed in wells that contain high concentrations of hydrogen sulfide because they are much more resistant to corrosion than are the 13% chromium and low alloy steels. These metals are called “duplex” because they contain ferritic and austenitic phases. Although more resistant to acid gas corrosion, duplex alloys are more susceptible to hydrochloric acid and hydrochloric/hydrofluoric acid corrosion than 13% chromium and low alloy steels due to high energy sites at their austenite-ferrite microstructural boundaries.

Various inhibitors for preventing the attack of acids on high chromium content steels have been proposed. Of the many inhibitors especially designed to prevent acid attack on well casings, very few provide satisfactory protection, especially at higher temperatures. Usually inhibitor intensifiers such as potassium iodide and formic acid are used to assist the corrosion inhibitor.

Accordingly, there is a need for the development of a corrosion inhibitor or inhibitor intensifier, especially for high chromium or duplex steels, that perform satisfactorily at higher temperatures.

### SUMMARY OF THE INVENTION

The invention provides a composition for treating a subterranean formation penetrated by a wellbore, the composition comprising at least 0.01% by weight of a compound according to a formula: 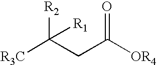
where each of R₁, R₂, R₃, and R₄ is independently:
a hydrogen;
a straight, branched, cyclic, or heterocyclic alkyl functional group;
a straight, branched, cyclic, or heterocyclic aryl functional group; or
a straight, branched, cyclic, or heterocyclic alkylaryl functional group; and
   The composition also comprises at least 1% by weight of an acid or acid precursor that is different from the compound according to the formula.

The invention also provides a method for treating a subterranean formation penetrated by a wellbore. The method comprises the steps of forming the composition and introducing the composition into the subterranean formation through the wellbore.

These and other aspects of the invention will be apparent to one skilled in the art upon reading the following detailed description. While the invention is susceptible to various modifications and alternative forms, specific embodiments thereof will be described in detail and shown by way of example. It should be understood, however, that it is different from intended to limit the invention to the particular forms disclosed, but, on the contrary, the invention is to cover all modifications and alternatives falling within the spirit and scope of the invention as expressed in the appended claims.

### DETAILED DESCRIPTION OF THE PREFERRED EMBODIMENTS

The invention provides a composition for treating a subterranean formation penetrated by a wellbore. The composition advantageously inhibits corrosion on metal surfaces used in wells of a subterranean formation. The composition is especially useful in acidizing treatments, which when combined with a corrosive aqueous fluid, inhibits the corrosion of metal surfaces, most especially, “duplex” chrome steel surfaces.

In accordance with the methods of the invention, a subterranean formation is treated with a composition of the invention, and the corrosive effects of the acidizing composition on metal in contact with the composition are reduced, thereby reducing the damage to the well that penetrates the subterranean formation. The method comprises the steps of forming the composition and introducing the composition into the wellbore. The method can further comprise the step of recovering the composition from the wellbore after the composition is introduced into the wellbore. The compositions and methods of the invention are based on the discovery that alpha, beta-unsaturated carboxylic acids and derivatives thereof provide unexpected increased corrosion inhibition against corrosive aqueous fluids as compared to prior art corrosion-inhibiting compositions.

In one embodiment, the composition relates to aqueous conformance control fluids and treatments. The water that can be used for the composition can be of any convenient or desired source, such as fresh water, seawater, natural brine, formulated brine, 2% KCl solution, and other water that does not undesirably interact with the composition of the invention. Formulated brine is manufactured by dissolving one or more soluble salts in water, natural brine, or seawater. Representative soluble salts are the chloride, bromide, acetate and formate salts of potassium, sodium, calcium, magnesium, and zinc.

According to one embodiment of the invention, the composition for inhibiting corrosion on metal according to the invention comprises a compound according to a formula: 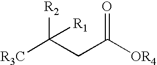
where each of R₁, R₂, R₃, and R₄ is independently:
a hydrogen;
a straight, branched, cyclic, or heterocyclic alkyl functional group;
a straight, branched, cyclic, or heterocyclic aryl functional group; or
a straight, branched, cyclic, or heterocyclic alkylaryl functional group.
   It is also envisioned that polymers of the above compounds can have one or more joined cyclic groups. The compound can also comprise a salt.

In one embodiment of the invention, the compound is selected from the group consisting of: (A) a chemical according to a formula: 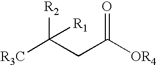
where each of R₁, R₂, R₃, and R₄ is independently:
a hydrogen;
a straight, branched, cyclic, or heterocyclic alkyl functional group;
a straight, branched, cyclic, or heterocyclic aryl functional group; or
a straight, branched, cyclic, or heterocyclic alkylaryl functional group;
   (C) a precursor of the chemical;
   (B) a derivative of the chemical;
   (D) a precursor of a derivative of the chemical; and any mixtures of the foregoing in any proportion.
      As used herein, a “precursor” of another chemical is a chemical related structurally to the other chemical and that theoretically reacts to form the other chemical. As used herein, a “derivative” of another chemical is a chemical related structurally to the other chemical and that is theoretically derivable from it.

In one aspect of this invention, the compound is further selected from the group consisting of: arabinaric acid, glucaric acid, tartaric acid, 1,1-cyclobutanedicarboxylic acid, 2-(2-propynyl)malonic acid, 2,2-bis(hydroxymethyl)butanoic acid, 2,2-Bis(hydroxymethyl)propionic acid, 2,2-diethylmalonic acid, 2,2-dihydroxymalonic acid hydrate, 2,2-dimethyl-1,3-dioxane-4,6-dione, 2,2-dimethylmalonic acid, 2-allylmalonic acid, 2-amino-2,4,5-trideoxypentonic acid, 2-butylmalonic acid, 2-ethylmalonic acid, 2-hydroxy-2-methylsuccinic acid, 2-isopropylmalonic acid, 2-methylmalonic acid, 2-methylserine, 3-(acryloyloxy)propanoic acid, 3-ethoxy-2-methyl-3-oxopropanoic acid, 3-ethoxypropanoic acid, 3-hydroxy-2-(hydroxymethyl)-2-methylpropanoic acid, 3-hydroxy-2,2-dimethylpropanoic acid, 3-hydroxy-2-oxopropanoic acid, 3-hydroxy-3-methylbutanoic acid, 3-hydroxybutanoic acid, 3-hydroxyproline, 3-methoxy-2-methyl-3-oxopropanoic acid, 3-methoxy-3-oxopropanoic acid, 3-methoxyalanine, 3-methoxybutanoic acid, 3-methoxypropanoic acid, 3-methoxyvaline, 4-amino-3-hydroxybutanoic acid, 4-hydroxy-4-methyltetrahydro-2H-pyran-2-one, 4-methyl-5-oxotetrahydro-3-furancarboxylic acid, diethyl malonate, dimethyl 2-ethylidenemalonate, dimethyl 2-methylmalonate, dimethyl malonate, disodium malonate, ethyl 3-ethoxypropanoate, ethyl 3-hydroxybutanoate, hydroxydihydro-2(3H)-furanone, lithium 3-hydroxy-2-oxopropanoate, malic acid, malonic acid, methyl 2-(1-hydroxyethyl)acrylate, methyl 2-amino-3-hydroxybutanoate, methyl 2-amino-3-hydroxypropanoate hydrochloride, methyl 2-oxo-2H-pyran-3-carboxylate, methyl 3,3-dimethoxypropanoate, methyl 3-hydroxy-2-(hydroxymethyl)-2-methylpropanoate, methyl 3-hydroxy-2, 2-dimethylpropanoate, methyl 3-hydroxyhexanoate, methyl 3-methoxypropanoate, N-acetylserine, potassium 3-methoxy-3-oxopropanoate, serine, sodium 3-hydroxybutanoate, sodium malonate dibasic monohydrate, tartronic acid, threonine, and any mixtures of the foregoing in any proportion.

In one embodiment, the compound for use in the composition is selected from the group consisting of 2-hydroxypropionic acid; 3-hydroxypropionic acid; 2-hydroxybutanoic acid; 3-hydroxybutanoic acid; 3-hydroxypentanoic acid; 3-hydroxyhexanoic acid; 4-hydroxybutanoic acid, or any mixtures of the foregoing in any proportion. Of these compounds, 3-hydroxypropionic acid is a particularly advantageous compound (herein sometimes abbreviated as “3-HP”).

Effective amounts of the compound, derivatives of the compound, or precursors of the compound, to provide generally acceptable levels of corrosion inhibition are those amounts in the range of from about 0.01% to about 10.0% by weight in the composition. Preferably, the compound, derivatives of the compound, and/or precursors of the compound is present in the composition in the amount in the range of from about 0.1% to 3% by weight in the composition. The compound, derivatives of the compound, and precursors of the compound can be used in conjunction with various other inhibitors, to intensify the effect of the corrosion inhibitor, as an “intensifier” for another corrosion inhibitor.

When combined with an acid or acid precursor (such as a delayed acid) that is different from the compound according to the formula or any other compounds mentioned above, the corrosion-inhibiting compositions of this invention provide reliable corrosion inhibition to the resulting acid composition at temperatures in the range of from about 80° F. to about 350° F. The corrosion-inhibiting compositions can include various conventional acids used to treat subterranean formations, while reducing the corrosive effects of these acids on metal surfaces, especially “duplex” chrome steels. The acid or acid precursor for use in the invention can be any inorganic acid, organic acid, or mixture. For example, the acid can be selected from the group consisting of hydrochloric acid, formic acid, acetic acid, citric acid, 3-hydroxypropionic acid, hydrofluoric acid, citric acid, ethylene diamine tetra acetic acid (“EDTA”), glycolic acid, sulfamic acid, carbonic acid, precursors of any of the foregoing, and any mixtures of the foregoing in any proportion. The acid can be present in the composition in an amount in the range of from about 1% to about 30% by weight of acid in the composition.

The metals that can be protected from corrosion by the corrosion-inhibiting compositions of the invention include ferrous-based metals such as iron and alloys of iron, for example, N-80, J-55, 13Cr and 22Cr, and non-ferrous metals such as aluminum, zinc, nickel, and copper, and their alloys. Other metals that can be protected from corrosion by the inventions are also contemplated.

The invention also provides methods for inhibiting the corrosion of metals in a wellbore that penetrates a subterranean formation. The method basically comprises the steps of forming a composition and introducing the composition into the wellbore.

The methods of the invention can further comprise the step of recovering the composition from the wellbore after the composition is introduced into the wellbore. Also, it should be understood by those skilled in the art that the composition comprising the compound, derivatives of the compound, and/or precursors of the compound can be introduced into the wellbore at any suitable point in treating a subterranean formation. Most preferably, the composition of the invention is introduced into the wellbore along with aqueous acid treatment fluids.

The corrosion inhibition composition of the invention can also include other corrosion inhibitors, intensifiers, pH control additives, surfactants, viscoelastic surfactants, breakers, fluid loss control additives, scale inhibitors, asphaltene inhibitors, paraffin inhibitors, salts, foamers, defoamers, emulsifiers, demulsifiers, iron control agents, solvents, mutual solvents, particulate diverters, gas phase, carbon dioxide, nitrogen, other biopolymers, synthetic polymers, friction reducers, any mixtures of the foregoing in any proportion, or the like. Further, the corrosion inhibition composition of the invention can also include synthetic gelling agents, natural gelling agents, surfactant gelling agents, crosslinkers, nitrogen, carbon dioxide, breakers, iron control agents, and hydrocarbons. Still further, the corrosion inhibition composition of the invention can also include foamed, gelled, and emulsified fluids.

As mentioned, the corrosion-inhibiting composition of this invention can also include a surfactant. When the surfactant is used in the corrosion-inhibiting composition, it is generally present in the composition in an amount in the range of from about 1% to about 45% by weight of the composition, although other composition amounts are also contemplated. Examples of suitable surfactants include alkylamidobetaines such as cocoamidopropyl betaine, alpha-olefin sulfonate, trimethyltallowammonium chloride, alkylethoxylate sulfate, trimethylcocoammonium chloride, ethoxylated nonyl phenol phosphate esters, non-ionic surfactants, cationic surfactants, alkyl phosphonate surfactants, linear alcohols, nonylphenol compounds, alkyoxylated fatty acids, alkylphenol alkoxylates, ethoxylated amides, ethoxylated alkyl amines, amphoteric surfactants (such as betaines), and any mixtures of the foregoing in any proportion. Other surfactants are also contemplated.

The corrosion-inhibiting composition can also comprise a solvent for the compound, precursors of the compound, derivatives of the compound, that also dissolves in water, referred to herein as a “mutual solvent”. Examples of such solvents are methyl alcohol, ethyl alcohol, isopropyl alcohol, ethylene glycol, propylene glycol, dimethyl formamide, N-methyl pyrrolidone, propylene glycol methyl ether and butyl cellosolve. When a mutual solvent of the type described above is included in the corrosion-inhibiting composition, it is generally present in an amount in the range of from about 1% to about 40% by weight of the composition.

In addition, the corrosion-inhibiting composition of the invention can include one or more quaternary ammonium compounds, one or more corrosion inhibitor activators and other components commonly used in corrosion-inhibiting formulations such as acetylenic alcohols, Mannich condensation products formed by reacting an aldehyde, a carbonyl containing compound and a nitrogen containing compound, coffee, tobacco, gelatin, cinnamaldehyde, cinnamaldehyde derivatives, fluorinated surfactants, quaternary derivatives of heterocyclic nitrogen bases, quaternary derivatives of halomethylated aromatic compounds, formamides, combinations of such compounds used in conjunction with iodine, quaternary ammonium compounds, unsaturated carbonyl compounds, unsaturated ether compounds, formamide, formic acid, fornates, and other sources of carbonyl, iodides, terpenes, and aromatic hydrocarbons. The quaternary ammonium compounds, which function as corrosion inhibitors and can be used in accordance with the present invention, have the formula:
(R)₄N⁺X⁻
wherein each R is the same or a different group selected from long chain alkyl groups, cycloalkyl groups, aryl groups or heterocyclic groups, and X is an anion such as a halide. The term “long chain” is used herein to mean hydrocarbon groups having in the range of from about 12 to about 20 carbon atoms. Examples of quaternary ammonium compounds which can be included in the corrosion-inhibiting composition are N-alkyl, N-cycloalkyl and N-alkylarylpyridinium halides such as N-cyclohexylpyridinium bromide or chloride, N-alkyl, N-cycloalkyl and N-alkylarylquinolinium halides such as N-dodecylquinolinium bromide or chloride, and the like. When a quaternary ammonium compound is included in a composition, it is generally present in an amount in the range of from about 1% to about 45% by weight of the composition.

Corrosion inhibitor activators, sometimes referred to as intensifiers, can function to activate another corrosion inhibitor. One example of such corrosion inhibitor activators that can be used in accordance with the invention includes quaternary ammonium compounds. Other corrosion inhibitor activators include cuprous iodide; cuprous chloride; antimony compounds such as antimony oxides, antimony halides, antimony tartrate, antimony citrate, alkali metal salts of antimony tartrate and antimony citrate, alkali metal salts of pyroantimonate and antimony adducts of ethylene glycol; bismuth compounds such as bismuth oxides, bismuth halides, bismuth tartrate, bismuth citrate, alkali metal salts of bismuth tartrate and bismuth citrate; iodine; iodide compounds; formic acid; and any mixtures of the foregoing of in any proportion. Examples of suitable intensifiers are also commercially available from Halliburton Energy Services, Inc., of Duncan, Oklahoma, are tradenamed/trademarked products. When a corrosion inhibitor activator is included in a composition, it is generally present in an amount in the range of from about 0.1 % to about 5.0% by weight of the composition.

Furthermore, iron control agents can be utilized with the corrosion inhibitor of the invention. One suitable iron control agent is citric acid; however, other iron control agents are also contemplated, such as the iron control agents disclosed in U.S. Pat. Nos. 6,315,045; 6,525,011; 6,534,448; and 6,706,668, all invented by Michael M. Brezinski, all of which have been assigned to Halliburton Energy Services, Inc., and all of which are incorporated by reference in their entirety.

To further illustrate the present invention, and not by way of limitation, the following examples are provided.

### EXAMPLE 1

To test the activity of the corrosion inhibitors of the present invention, corrosion test coupons of 13Cr, 22Cr or N-80 carbon steel were used. A weighed coupon of the metal was suspended from a Teflon® holder inside a glass cell to which was added 100 mL of acid solution with either no inhibitor, traditional corrosion inhibitors (such as Halliburton's MSA-III, HAI-404, HII-124B, and/or HII-500M), and/or the above-described 3-hydroxypropionic acid (“3-HP”) as a corrosion inhibitor or inhibitor intensifier. The acids tested were acetic acid (10% w/v solution) and hydrochloric acid (15% w/v solution). In addition, 3-HP (15.75% w/v solution) was tested as the acid solution without any other corrosion inhibitor. The glass cell was then placed in an autoclave. The autoclave was pressurized to 1000 pounds per square inch gauge (“psig”) using nitrogen and heated to the desired temperature for the desired total contact time. In the composition, 3-HP was tested by using 0.5% v/v of a 42% w/v active 3-HP aqueous solution. The solutions were heated to 250° F. or 300° F. as indicated in Table 1. Corrosion test coupons were immersed in the solutions for the stated time periods while maintaining the temperatures of the solutions at either 250° F. or 300° F.

TABLE 1
Comparison of Corrosion Losses (1000 psig)

| Acid | Inhibitor | Metal | Temp. (° F.) | Time | Corrosion loss (lb/ft²) |
|---|---|---|---|---|---|
| 10% Acetic acid | None | 13Cr | 300 | 24 h | 0.109 |
| 10% Acetic acid | 0.5% MSA III | 13Cr | 300 | 24 h | 0.041 |
| 10% Acetic acid | 0.5% MSA III + 0.5% | 13Cr | 300 | 24 h | 0.008 |
| | 3-HP (42% soln.) | | | | |
| 10% Acetic acid | 0.5% 3-HP (42% soln.) | 13Cr | 300 | 24 h | 0.099 |
| 15.75% 3-HP | None | 13Cr | 300 | 24 h | 0.025 (avg) |
| 10% Acetic acid | None | N80 | 300 | 24 h | 0.327 |
| 10% Acetic acid | 0.5% MSA III | N80 | 300 | 24 h | 0.006 |
| 10% Acetic acid | 0.5% MSA III + 0.5% | N80 | 300 | 24 h | 0.011 |
| | 3-HP (42% soln.) | | | | |
| 10% Acetic acid | 0.5% 3-HP (42% soln.) | N80 | 300 | 24 h | 0.389 |
| 15.75% 3-HP | None | N80 | 300 | 24 h | 0.229 |
| 15% HCl | 2% HAI-404 + 0.5% | 13Cr | 300 | 6 h | 0.625 |
| | 3-HP (42% soln.) | | | | |
| 15% HCl | 2% HAI-404 + 2% | 13Cr | 300 | 6 h | 0.047 |
| | HII-500M | | | | |
| 15% HCl | 2% HAI-404 + 2% | 13Cr | 300 | 6 h | 0.022 |
| | HII-500M + 0.5% | | | | |
| | 3-HP (42% soln.) | | | | |
| 15% HCl | 2% HAI-404 + 0.5% | 13Cr | 300 | 3 h | 0.354 |
| | 3-HP (42% soln.) | | | | |
| 15% HCl | 1% HAI-404 + 0.5% | 22Cr | 250 | 3 h | 0.455 |
| | 3-HP (42% soln.) | | | | |
| 15% HCl | 1% HAI-404 + 15 lb/Mgal | 22Cr | 250 | 3 h | 0.028 |
| | HII-124B | | | | |
| 15% HCl | 1% HAI-404 + 15 lb/Mgal | 22Cr | 250 | 3 h | 0.034 |
| | HII-124B + 0.5% | | | | |
| | 3-HP (42% soln.) | | | | |
| 15% HCl | 2% HAI-404 + 0.5% | 22Cr | 300 | 6 h | 0.705 |
| | 3-HP (42% soln.) | | | | |
| 15% HCl | 2% HAI-404 + 2% | 22Cr | 300 | 6 h | 0.033 |
| | HII-500M | | | | |
| 15% HCl | 2% HAI-404 + 2% | 22Cr | 300 | 6 h | 0.023 |
| | HII-500M + 0.5% | | | | |
| | 3-HP (42% soln.) | | | | |

In corrosion testing of 13% chrome steel (“13Cr”) with 10% acetic acid, corrosion loss was tested (a) with no inhibitor, (b) with Halliburton's MSA-III inhibitor alone, and (c) with MSA-III inhibitor and 3-HP, and 3-HP alone. The 3-HP used in addition to the 0.5% MSA III inhibitor provides for a reduced corrosion loss as compared to no inhibitor at all, the 0.5% MSA III inhibitor alone, or to a 0.5% concentration of a 42% solution of 3-HP alone. The results show that high chrome steel corrosion loss is reduced by 80% when used in conjunction with the MSA-III compared to MSA-III alone.

In corrosion testing with a low-chrome steel (“N80”) with 10% acetic acid, corrosion loss was tested (a) with no inhibitor, (b) with Halliburton's MSA-III inhibitor alone, (c) with MSA-III inhibitor and 3-HP, and (d) with 3-HP alone. The 3-HP does not appear to reduce corrosion loss for this low-chrome steel, unlike when 3-HP is used with the high-chrome steel 13Cr. Without being limited by any theoretical explanation, it is believed that one possible explanation resulting in the difference in effect that the 3-HP has on high-chromium alloys such as 13Cr as compared to low-chrome steel N80 is that the 3-HP is polymerized on the chromium steel with chromium acting as a polymerization catalyst. Thus, 3-HP is believed to be more effective on metals that have higher chromium content. In this way, a thin film is formed on the high-chromium surface, such as with 13Cr, helping to protect the high-chromium alloys from corrosion loss.

In corrosion testing of 13% chrome steel (“13Cr”) with 15% hydrochloric acid, the corrosion loss is known to be very high, greater than 0.05 lb/ft². As shown in Table 1, corrosion loss was tested (a) with Halliburton's HAI-404 corrosion inhibitor and 3-HP, (b) with HAI-404 and Halliburton's HII-500M intensifier, and (c) with HAI-404, HII-SOOM, and 3-HP. In this system, the 3-HP works best when used in conjunction with both the inhibitor and the intensifier, as indicated by the lower concentration of corrosion loss of 0.022 lb/ft².

Similarly, in corrosion testing of 22% chrome duplex steel (“22Cr”) with 15% hydrochloric acid, corrosion loss was tested (a) with Halliburton's HAI-404 corrosion inhibitor and 3-HP, (b) with HAI-404 and Halliburton's intensifier HII-124B, and (c) with HAI-404, HII-124B, and 3-HP. The corrosion loss of 0.028 lb/ft² for HAI-404 and HII-124B as compared to 0.034 lb/ft² for HAI-404 and HII-124B and 3-HP is believed to be within experimental error, or equivalent; however, conditions could exist where this is not the case.

In corrosion testing of 22% chrome duplex steel (“22Cr”) with 15% hydrochloric acid, corrosion loss was tested (a) with Halliburton's HAI-404 corrosion inhibitor and 3-HP, (b) with HAI-404 and Halliburton's HII-500M intensifier, and (c) with HAI-404, HII-500M, and 3-HP. In this system, the 3-HP again works best when used in conjunction with both the inhibitor and the intensifier, as indicated by the lower concentration of corrosion loss of 0.023 lb/ft².

When HCl is used as the acid, the preliminary results indicate that 3-HP work better to further intensify HII-500 as compared to HII-124B; however, conditions could exist where this is not the case. Compare the corrosion test results on 22Cr with 15% hydrochloric acid, even though the temperature and time conditions for the tests are different.

Finally, in corrosion testing of 13Cr and N80 with 15.75% 3-HP as the acid without any separate inhibitor or intensifier, a comparison of these tests shows that 3-HP corrodes 13Cr steel about 90% less than it corrodes N80 steel.

After careful consideration of the specific and exemplary embodiments of the present invention described herein, a person of ordinary skill in the art will appreciate that certain modifications, substitutions and other changes may be made without substantially deviating from the principles of the present invention. The detailed description is illustrative, the spirit and scope of the invention being limited only by the appended claims.

What is claimed is:

1. A composition for treating a subterranean formation penetrated by a wellbore, the composition comprising:
a) at least 0.01% by weight of a compound according to a formula: 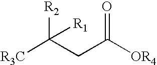
where each of R₁, R₂, R₃, and R₄ is independently:
a hydrogen;
a straight, branched, cyclic, or heterocyclic alkyl functional group;
a straight, branched, cyclic, or heterocyclic aryl functional group; or
a straight, branched, cyclic, or heterocyclic alkylaryl functional group; and
b) at least 1% by weight of an acid or acid precursor that is different from the compound according to the formula.

2. The composition according to claim 1, the composition comprising:
a) at least 0.01% by weight of 3-hydroxypropionic acid; and
b) at least 1% by weight of an acid or acid precursor that is different from 3-hydroxypropionic acid.

3. The composition according to claim 1, wherein compound according to the formula is up to about 10.0% by weight in the composition.

4. The composition according to claim 2, wherein 3-hydroxypropionic acid is up to about 10.0% by weight in the composition.

5. The composition according to claim 1, wherein the acid or acid precursor that different from the compound according to the formula is selected from the group consisting of hydrochloric acid, formic acid, acetic acid, citric acid, 3-hydroxypropionic acid, hydrofluoric acid, citric acid, ethylene diamine tetra acetic acid, glycolic acid, sulfamic acid, carbonic acid, precursors of any of the foregoing, and any mixtures of the foregoing in any proportion.

6. The composition according to claim 2, wherein the acid or acid precursor that is different from the 3-hydroxypropionic acid is selected from the group consisting of hydrochloric acid, formic acid, acetic acid, citric acid, 3-hydroxypropionic acid, hydrofluoric acid, citric acid, ethylene diamine tetra acetic acid, glycolic acid, sulfamic acid, carbonic acid, precursors of any of the foregoing, and any mixtures of the foregoing in any proportion.

7. The composition according claim 1, further comprising a surfactant.

8. The composition according claim 1, further comprising a surfactant selected from the group consisting of alkoxylated fatty acids, alkylphenol alkoxylates, ethoxylated alkyl amines, and any mixtures of the foregoing in any proportion.

9. The composition according to claim 1, further comprising a corrosion inhibitor activator selected from the group consisting of cuprous iodide, cuprous chloride, antimony compounds, bismuth compounds, iodine, iodide compounds, formic acid, and any mixtures of the foregoing in any proportion.

10. The composition according to claim 1, further comprising an inhibitor or an inhibitor intensifier selected from the group consisting of cinnamaldehyde, cinnamaldehyde derivative, acetylenic alcohol, Mannich condensation product, quaternary ammonium compound, and any mixtures of the foregoing in any proportion.

11. A method for treating a subterranean formation penetrated by a wellbore, the method comprising the steps of:
a) forming a composition comprising:
i) at least 0.01% by weight of a compound according to a formula: 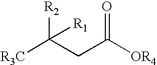
where each of R₁, R₂, R₃, and R₄ is independently:
a hydrogen;
a straight, branched, cyclic, or heterocyclic alkyl functional group;
a straight, branched, cyclic, or heterocyclic aryl functional group; or a straight, branched, cyclic, or heterocyclic alkylaryl functional group; and
ii) at least 1% by weight of an acid or acid precursor that is different from the compound according to the formula; and
b) introducing the composition into the subterranean formation through the wellbore.

12. The method according to claim 11, wherein the compound selected from the group consisting of 2-hydroxypropionic acid; 3-hydroxypropionic acid; 2-hyroxybutanoic acid; 3-hydroxybutanoic acid; 3-hydroxypentanoic acid; 3-hydroxyhexanoic acid; 4-hydroxybutanoic acid; and any mixtures of the foregoing in any proportion.

13. The method according to claim 11, the compound comprises 3-hydroxypropionic acid.

14. The method according to claim 11, wherein compound according to the formula is up to about 10.0% by weight in the composition.

15. The method according to claim 12, wherein compound selected from the group is up to about 10.0% by weight in the composition.

16. The method according to claim 13, wherein 3-hydroxypropionic acid is up to about 10.0% by weight in the composition.

17. The method according to claim 11, wherein the acid or acid precursor that is different from the compound according to the formula is selected from the group consisting of hydrochloric acid, formic acid, acetic acid, citric acid, 3-hydroxypropionic acid, hydrofluoric acid, citric acid, ethylene diamine tetra acetic acid, glycolic acid, sulfamic acid, carbonic acid, precursors of any of the foregoing, and any mixtures of the foregoing in any proportion.

18. The method according to claim 12, wherein the acid or acid precursor that is different from the compound selected from the group is selected from the group consisting of hydrochloric acid, formic acid, acetic acid, citric acid, 3-hydroxypropionic acid, hydrofluoric acid, citric acid, ethylene diamine tetra acetic acid, glycolic acid, sulfamic acid, carbonic acid, precursors of any of the foregoing, and any mixtures of the foregoing in any proportion.

19. The composition according to claim 13, wherein the acid or acid precursor that is different from 3-hydroxypropionic acid is selected from the group consisting of hydrochloric acid, formic acid, acetic acid, citric acid, 3-hydroxypropionic acid, hydrofluoric acid, citric acid, ethylene diamine tetra acetic acid, glycolic acid, sulfamic acid, carbonic acid, precursors of any of the foregoing, and any mixtures of the foregoing in any proportion.

20. The method according claim 11, further comprising a surfactant.

21. The method according claim 1 1, further comprising a surfactant selected from the group consisting of alkoxylated fatty acids, alkylphenol alkoxylates, ethoxylated alkyl amines, and any mixtures of the foregoing in any proportion.

22. The method according to claim 11, wherein the composition further comprises a corrosion inhibitor activator selected from the group consisting of cuprous iodide, cuprous chloride, antimony compounds, bismuth compounds, iodine, iodide compounds, formic acid, and any mixtures of the foregoing in any proportion.

23. The method according to claim 11, wherein the composition further comprises an inhibitor or an inhibitor intensifier selected from the group consisting of cinnamaldehyde, cinnainaldehyde derivative, acetylenic alcohol, Mannich condensation product, quaternary ammonium compound, and any mixtures of the foregoing in any proportion.

24. The method according to claim 11, wherein the method further comprises the step of producing hydrocarbon from the wellbore after the acidizing composition is introduced into the wellbore.

25. A method for treating a subterranean formation penetrated by a wellbore, the method comprising the steps of:
a) forming a composition comprising:
i) at least 0.01% by weight of a compound selected from the group consisting of:
(A) a chemical according to a formula: 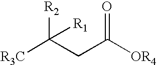
where each of R₁, R₂, R₃, and R₄ is independently:
a hydrogen;
a straight, branched, cyclic, or heterocyclic alkyl functional group;
a straight, branched, cyclic, or heterocyclic aryl functional group; or
a straight, branched, cyclic, or heterocyclic alkylaryl functional group;
(B) a precursor of the chemical;
(C) a derivative of the chemical;
(D) a precursor of a derivative the chemical; and
any mixture of the foregoing in any proportion; and
ii) at least 1% by weight of an acid or acid precursor that is different from the compound according to the formula; and
b) introducing the composition into the subterranean formation through the wellbore.

26. The method according to claim 25, wherein the compound is further selected from the group consisting of: arabinaric acid, glucaric acid, tartaric acid, 1,1-cyclobutanedicarboxylic acid, 2-(2-propynyl)malonic acid, 2,2-bis(hydroxymethyl)butanoic acid, 2,2-Bis(hydroxymethyl)propionic acid, 2,2-diethylmalonic acid, 2,2-dihydroxymalonic acid hydrate, 2,2-dimethyl-1,3-dioxane-4,6-dione, 2,2-dimethylmalonic acid, 2-allylmalonic acid, 2-amino-2,4,5-trideoxypentonic acid, 2-butylmalonic acid, 2-ethylmalonic acid, 2-hydroxy-2-methylsuccinic acid, 2-isopropylmalonic acid, 2-methylmalonic acid, 2-methylserine, 3-(acryloyloxy)propanoic acid, 3-ethoxy-2-methyl-3-oxopropanoic acid, 3-ethoxypropanoic acid, 3-hydroxy-2-(hydroxymethyl)-2-methylpropanoic acid, 3-hydroxy-2, 2-dimethylpropanoic acid, 3-hydroxy-2-oxopropanoic acid, 3-hydroxy-3-methylbutanoic acid, 3-hydroxybutanoic acid, 3-hydroxyproline, 3-methoxy-2-methyl-3-oxopropanoic acid, 3-methoxy-3-oxopropanoic acid, 3-methoxyalanine, 3-methoxybutanoic acid, 3-methoxypropanoic acid, 3-methoxyvaline, 4-amino-3-hydroxybutanoic acid, 4-hydroxy-4-methyltetrahydro-2H-pyran-2-one, 4-methyl-5-oxotetrahydro-3-furancarboxylic acid, diethyl malonate, dimethyl 2-ethylidenemalonate, dimethyl 2-methylmalonate, dimethyl malonate, disodium malonate, ethyl 3-ethoxypropanoate, ethyl 3-hydroxybutanoate, hydroxydihydro-2(3H)-furanone, lithium 3-hydroxy-2-oxopropanoate, malic acid, malonic acid, methyl 2-(1-hydroxyethyl)acrylate, methyl 2-amino-3-hydroxybutanoate, methyl 2-amino-3-hydroxypropanoate hydrochloride, methyl 2-oxo-2H-pyran-3-carboxylate, methyl 3,3-dimethoxypropanoate, methyl 3-hydroxy-2-(hydroxymethyl)-2-methylpropanoate, methyl 3-hydroxy-2,2-dimethylpropanoate, methyl 3-hydroxyhexanoate, methyl 3-methoxypropanoate, N-acetylserine, potassium 3-methoxy-3-oxopropanoate, serine, sodium 3-hydroxybutanoate, sodium malonate dibasic monohydrate, tartronic acid, threonine, and any mixtures of the foregoing in any proportion.
